(19) United States
(12) Patent Application Publication
(10) Pub. No.: US 2014/0230307 A1
(43) Pub. Date: Aug. 21, 2014

(54) APPARATUS, SYSTEM, AND METHOD FOR ENHANCING A DECOY

(71) Applicant: Todd Keola Bartholomew, Syracuse, UT (US)

(72) Inventor: Todd Keola Bartholomew, Syracuse, UT (US)

(21) Appl. No.: 14/270,278

(22) Filed: May 5, 2014

Related U.S. Application Data
(63) Continuation-in-part of application No. 13/134,263, filed on Jun. 3, 2011, now Pat. No. 8,752,326.

(51) Int. Cl. A01M 31/06

(52) U.S. Cl. CPC A01M 31/06
USPC 43/2

(57) ABSTRACT

An apparatus, system, and method are disclosed for enhancing a decoy. The apparatus includes a sheet of material and a coupling member. The sheet of material has a first side positioned opposite a second side. The sheet of material has a profile shaped in a silhouette of an animal. The coupling member is configured to removably couple the sheet of material to a decoy

### CROSS-REFERENCES TO RELATED APPLICATIONS

This application is a continuation-in-part application of and claims priority to U.S. patent application Ser. No. 13/134,263 entitled “DECOY REFLECTION AND SHADOW” and filed on Jun. 3, 2011 for Todd Keola Bartholomew, which is incorporated herein by reference.

### FIELD OF THE INVENTION

This invention relates to decoys and more particularly relates to an apparatus, system and method for enhancing a decoy.

### BACKGROUND

A decoy is a man-made object resembling a real animal. For example, duck decoys are sometimes used in duck hunting to simulate a real duck to attract real ducts towards a hunter or hunters. Ducks and other waterfowl typically fly at a relatively high altitude and therefore may not see a decoy at or near ground level.

A waterfowl decoy may be used on dry-land or on the surface of water. Decoys used on water are typically buoyant so that the decoys float on the surface of the water. Waves or wind may cause the decoys to float unnaturally. In a worst case scenario, wind or wave may cause the decoy to capsize.

### SUMMARY

From the foregoing discussion, it should be apparent that a need exists for an apparatus, system, and method that enhances a decoy. Beneficially, such an apparatus, system, and method would create a greater contrast between the decoy and its immediate surroundings. The apparatus, system, and method to enhance a decoy should be light weight, durable, keeps its form, and bend naturally with the waves and wind to support the decoy on water.

The present invention has been developed in response to the present state of the art, and in particular, in response to the problems and needs in the art that have not yet been fully solved by currently available decoy enhancement systems. Accordingly, the present invention has been developed to provide an apparatus, system, and method for enhancing a decoy that overcome many or all of the above-discussed shortcomings in the art.

The present subject matter relates to an artificial reflection or dark shadow used in bird or animal attracting activities. The general idea of the apparatus is to allow birds that are flying and that are prone to being decoyed, to see an artificial reflection off of the water or an artificial dark shadow from further away and from greater angles, thus getting the bird's attention and helping to decoy them closer. The Decoy Reflection and Shadow can be attached to a decoy, or used by itself. The apparatus is buoyant and can be a full aerial view of a bird when looking straight down on the apparatus. In other embodiments, the apparatus may be a silhouette of a bird or decoy, giving the decoy a larger foot print.

The artificial reflection or shadow may be used by itself or attached to a floating decoy as in waterfowl hunting to simulate the colored reflection off of the water or the dark shadow of a decoy as a live bird would have while sitting on the water's surface. The decoy reflection and shadow can be used either floating on a water surface or placed on the ground as in field hunting.

The reflection-shadow can be of varying lengths, depths and widths to simulate the shadow and/or reflection of a decoy or live bird at differing times of the day and at different sun positions. In certain embodiments, one side of the apparatus is printed with a simulated colored reflection of an animal (i.e., a duck, goose, etc.) In such an embodiment, the other the side of the apparatus may be printed with a dark shadow. In other embodiments, only one side includes an image. The apparatus may be an entire aerial view of a bird or just a side view. In one embodiment, the apparatus is printed or colored to mimic a specific species of waterfowl or decoy, thus giving the appearance of a reflection. In certain embodiments, the apparatus is colored dark to simulate a natural shadow.

The apparatus, in one embodiment, can also stabilize floating decoys and allow birds in the air and other animals to see the decoy from greater distances and from greater angles. The device can be attached to the underside of a floating decoy or to its keel giving the decoy greater stability against waves and winds. When attached to a floating decoy, the apparatus stabilizes the decoy and protects the decoy from waves and winds which may over turn the decoy or make the decoy “bob” unnaturally on the surface of the water.

In one embodiment, the apparatus is made of a buoyant material (i.e., a neoprene material or other buoyant material). In such an embodiment, apparatus is light weight, durable, keeps its form, and bends naturally with the waves as is typical of waterfowl.

The apparatus, when used on water may be made of any buoyant material. When used on land, the apparatus made out of any ridged flat or semi flat material. Of course, one of skill in the art will recognize that the apparatus may be made of a buoyant material even when the apparatus is used on land.

Accordingly, an apparatus to simulate one of a reflection and a shadow of an animal is disclosed. The apparatus includes a sheet of material and a coupling member. The sheet of material has a first side positioned opposite a second side. The sheet of material has a profile shaped in a silhouette of an animal. The coupling member is configured to removably couple the sheet of material to a decoy.

In one embodiment, the sheet of material is removably coupleable to the decoy at either a side of the decoy or a keel of the decoy. In another embodiment, the coupling member is an aperture in the sheet of material. In such an embodiment, the aperture is sized to receive a keel of a decoy to removably couple the sheet of material to the decoy. In an exemplary embodiment, the sheet of material is made of an elastic material and the aperture is sized to elastically extend about the keel of the decoy. The elasticity of the sheet of material maintains the aperture about the keel of the decoy to removably couple the sheet of material to the decoy.

In another embodiment, the coupling member is a band positionable about a keel of a decoy to removably couple the sheet of material to the decoy. In other embodiments, the coupling member includes a first coupling element and a second coupling element. In such embodiments, the first coupling element is attached to the sheet of material and the second coupling element attached to the decoy. The first coupling element is engageable with the second coupling element to removably couple the sheet of material to the decoy.

In one embodiment, the coupling member is a hook and loop fastening system. In such an embodiment either a hooking portion or a loop portion of the hook and loop fastening system is attached to the sheet of material. The other part of the hook and loop fastening system (either the hooking portion or the loop portion of the hook and loop fastening system) is attached to the decoy.

In other embodiments, the coupling member is a snap fastening system. In yet another embodiment, the coupling member includes at least one strap extending from either the side of the decoy, the keel of the decoy, or both. A terminating end of the e strap includes a fastening element that is removeably coupleable with the sheet of material.

In an exemplary embodiment, the first side of the sheet of material is colored to simulate an animal's shadow. In such an embodiment the second side of the sheet of material may include an image colored to simulate a reflection of the animal.

In certain embodiments the profile shaped in the silhouette of the animal is a first profile. In such an embodiment, the sheet of material may include a second profile shaped in the silhouette of the animal with the second profile mirroring the first profile.

An apparatus to enhance a decoy is also disclosed. The apparatus includes a sheet of material and a coupling member. The sheet of material has a first side disposed opposite a second side. Additionally, the sheet of material has a profile shaped in a silhouette of an animal. The coupling member is configured to repeatedly couple and uncouple the sheet of material to a decoy. In certain embodiments, the sheet of material is repeatedly coupleable and uncoupleable to the decoy at either a side of the decoy, a keel of the decoy, or both.

In an exemplary embodiment, the coupling member includes an aperture in the sheet of material. The aperture is sized to receive a keel of a decoy to repeatedly couple and uncouple the sheet of material to the decoy. In other embodiments, the coupling member includes a band positionable about a keel of a decoy to repeatedly couple and uncouple the sheet of material to the decoy.

In one embodiment, the coupling member includes a first coupling element and a second coupling element. In such an embodiment, the first coupling element is attached to the sheet of material and the second coupling element attached to the decoy. The first coupling element is engageable with the second coupling element to repeatedly couple and uncouple the sheet of material to the decoy.

In yet another embodiment, the profile shaped in the silhouette of the animal is a first profile. In such an embodiment, the sheet of material may include a second profile shaped in the silhouette of the animal with the second profile mirroring the first profile.

An apparatus to enhance a decoy is also disclosed that includes a sheet of material and a coupling member. The sheet of material has a first side positioned opposite a second side. The sheet of material also has a profile shaped in a silhouette of an animal. The coupling member is configured to repeatedly couple and uncouple the sheet of material to a decoy. Thus, the sheet of material is repeatedly coupleable and uncoupleable to the decoy at either a side of the decoy, a keel of the decoy, or both.

In certain embodiments, the coupling member is an aperture in the sheet of material. In such an embodiment, the aperture is sized to receive a keel of a decoy to repeatedly couple and uncouple the sheet of material to the decoy.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a side view illustrating one embodiment of a conventional waterfowl decoy in accordance with the present subject matter;

FIG. 1B is a front view further illustrating the waterfowl decoy of FIG. 1 in accordance with the subject matter;

FIG. 2 is a top view illustrating an apparatus to simulate one of a reflection and a shadow of an animal in accordance with one embodiment of the present subject matter;

FIG. 3 is a top view further illustrating the apparatus to simulate one of a reflection and a shadow of an animal of FIG. 2 in accordance with one embodiment of the present subject matter;

FIG. 4 is a top view illustrating an apparatus to simulate one of a reflection and a shadow of an animal wherein the coupling member is an aperture for receiving a keel of a decoy in accordance with one embodiment of the present subject matter;

FIG. 5 is a top view illustrating an apparatus to simulate one of a reflection and a shadow of an animal wherein the coupling member is a band positionable about a keel of a decoy in accordance with one embodiment of the present subject matter;

FIG. 6 is a top view illustrating an apparatus to simulate one of a reflection and a shadow of an animal wherein the coupling member is a hook and loop fastener coupleable to a decoy in accordance with one embodiment of the present subject matter;

FIG. 7 is a top view illustrating an apparatus to simulate one of a reflection and a shadow of an animal wherein the coupling member is a snap fastener coupleable to a decoy in accordance with one embodiment of the present subject matter;

FIG. 8 is a top view illustrating an apparatus to simulate one of a reflection and a shadow of an animal wherein the coupling member is a strap extending from a side of the decoy to removably couple the apparatus to the decoy in accordance with one embodiment of the present subject matter; and

FIG. 9 is a top view illustrating an apparatus to simulate one of a reflection and a shadow of an animal wherein the apparatus includes two mirrored silhouettes of an animal in accordance with one embodiment of the present subject matter.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

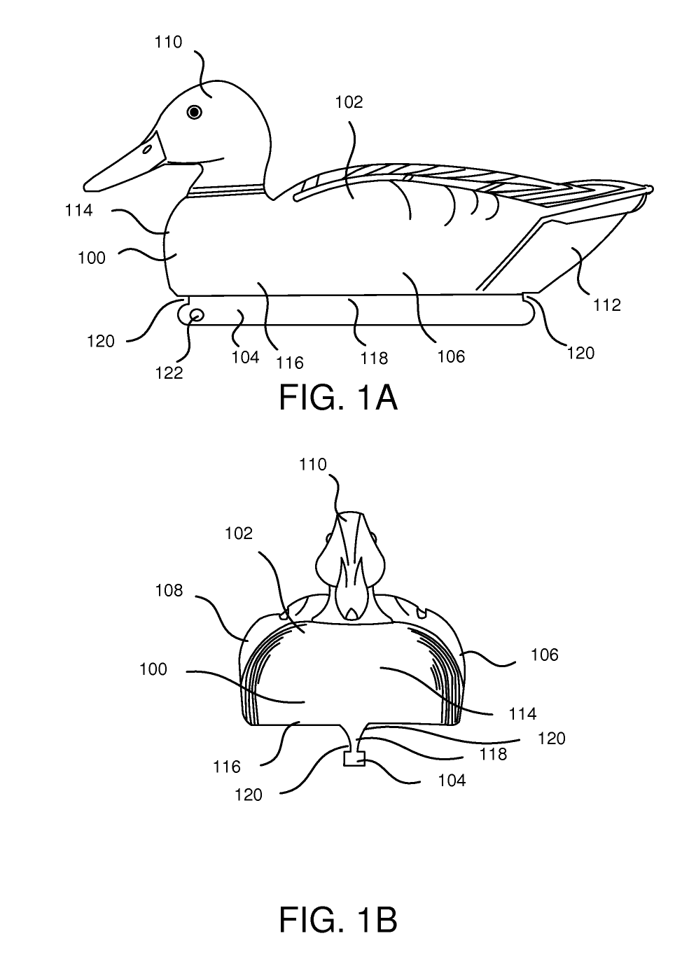

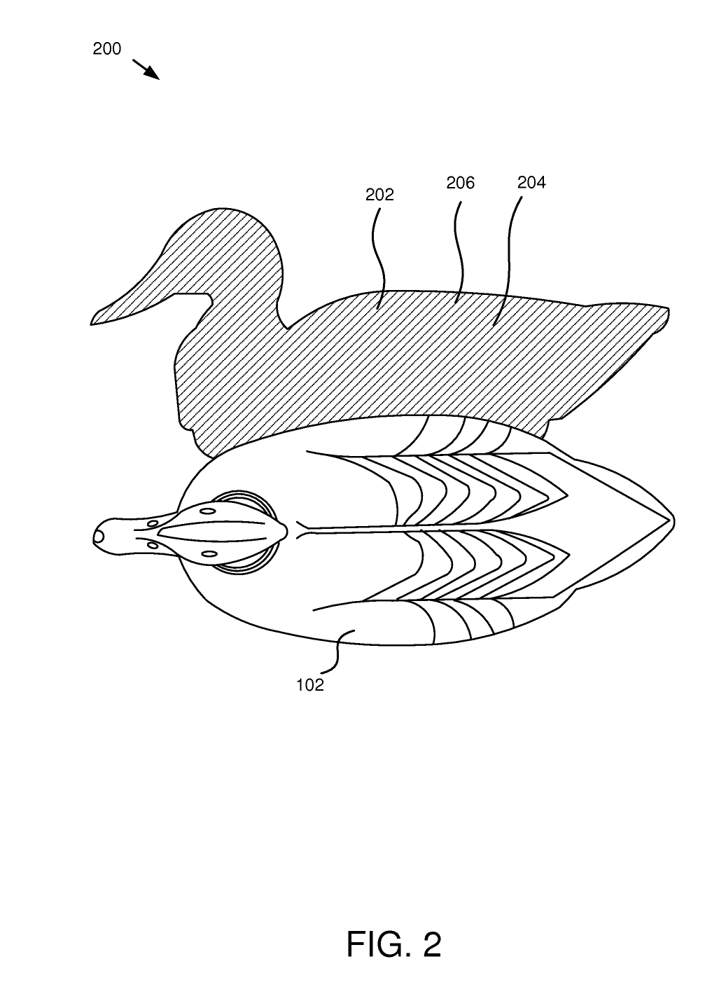

FIG. 1A depicts one embodiment of a side view of a conventional waterfowl decoy 100 as is known in the art. FIG. 1B depicts a front view of the waterfowl decoy 100 of FIG. 1A. As will be evident to one of skill in the art, a conventional waterfowl decoy 100 typically includes a body portion 102 and a keel 104.

In certain embodiments, the body portion 102 is shaped to simulate a waterfowl. In the embodiment illustrated in FIGS. 1A and 1B, the body portion 102 of the waterfowl decoy 100 is shaped to simulate a duck. While the embodiment illustrated in FIGS. 1A and 1B depict the body portion 102 decoy as simulating a duck, one of skill in the art will recognize that in other embodiments, the body portion 102 of the waterfowl decoy 100 may be shaped to simulate other waterfowl such as a goose, swan, etc.

In certain embodiments, the body portion 102 of the decoy 100 is three-dimensional. Thus, in one embodiment, the body portion 102 of the decoy 100 includes a first side 106 disposed opposite a second side 108. In the embodiment illustrated in FIGS. 1A and 1B, the first and second sides, 106 and 108 respectively, are shaped to simulate a duck's wings.

One of skill in the art will also recognize that a waterfowl decoy will also typically have a head 110 and a tail 112. The head 110 is often coupled to a chest 114 portion of the decoy 100. For the purposed discussed herein, a side of a decoy 100 may be consider the area between the chest portion 114 and the tail 112 of the decoy.

In most conventional waterfowl decoy's 100, the decoy 100 is hollow or filled with a material having a density substantially less than a density of water. Thus, the decoy 100 is designed to float on water. In such embodiments, the body portion 102 of the decoy 100 extends above the water and the keel 104 of the decoy extends below the water. In certain decoys 100, the keel is weighted to counter balance the body portion of the decoy 100 and keep the body portion positioned above the surface of the water.

The keel 104 typically extends along substantially a length of a bottom 116 portion of the decoy 100. In some conventional decoys 100, the keel 104 of the decoy is coupled to the body portion 102 of the decoy 100 by an intermediate section of material 118. Because the intermediate section of material 118 is simply material to connect the weighted keel 104 portion to the body portion 102 of the decoy, the intermediate section of material 118 is often smaller than the keel 104. Accordingly, the intermediate section of material 118 may define an indented area 120.

In certain embodiments, a user may wish to couple additional weight to the decoy 100 to keep the decoy 100 positioned where the user wants the decoy 100 positioned. Thus, in certain embodiments, the decoy 100 may also include an aperture 122 disposed through the keel 104 or the intermediate section of material 118. A line or chord (not shown) may be coupled to the aperture 122 at one end of the line or chord and to a weighted element at the other end of the line or chord. When the decoy 100 is not in use, the indented area in the intermediate section of material 118 may be used to wrap the line or chord about the keel 104 of the decoy.

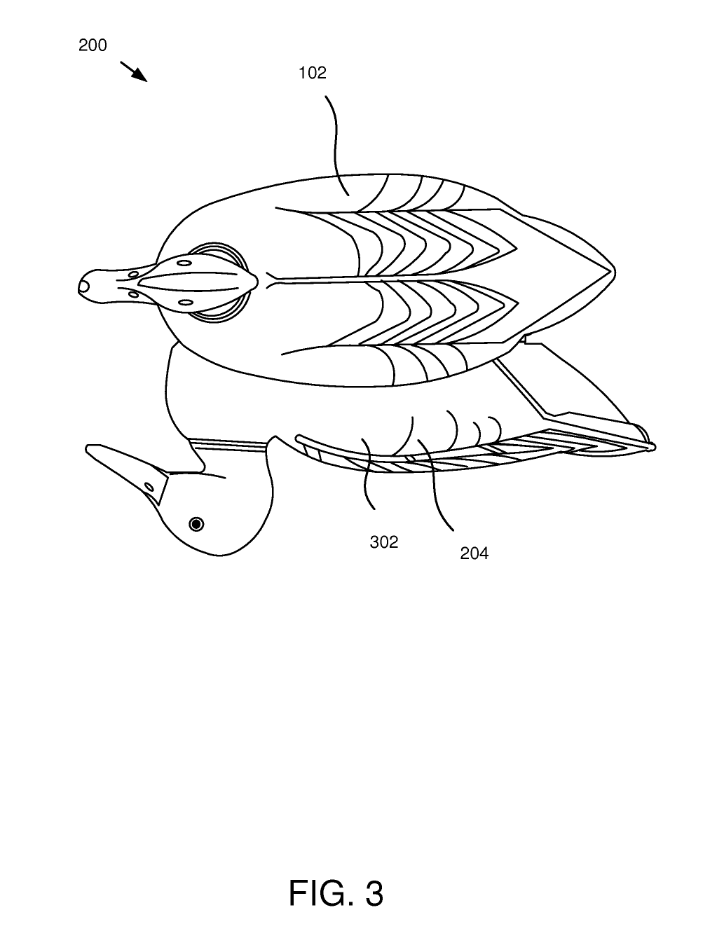

FIG. 2 depicts a top view of illustrating one embodiment of an apparatus 200 to simulate either a reflection or a shadow of an animal in accordance with the present subject matter. FIG. 3 depicts a top view further illustrating one embodiment of the apparatus 200 of FIG. 2 in accordance with the present subject matter.

One of skill in the art will recognize that when looking straight down on a waterfowl or decoy 102 from an aerial view one does not see a three-dimensional image of the waterfowl or decoy 102. What is most prominent is the flat looking body of the bird or decoy 102, the reflection on the water or the dark shadow of the bird or decoy 102. The present subject matter simulates and enhances this aerial view.

In one embodiment, the apparatus 200 includes a sheet of material 204 and a coupling member (discussed below) configured to removably coupled the sheet of material 204 to a decoy 102. The sheet of material 204, in certain embodiments, has a profile shaped in the silhouette of an animal. For example, in the embodiment illustrated in FIG. 2 and FIG. 3, the sheet of material 204 is shaped in the silhouette of a duck.

The sheet of material 204 has a first side 206 (FIG. 2) disposed opposite a second side 304 (FIG. 3). In the embodiment illustrated in FIG. 3, the sheet of material 204 has been flipped to show the second side 304 of the sheet of material 204. In certain embodiments, the first side 206 of the sheet of material 204 may include a first image or coloring scheme and the second side 304 of the sheet of material 204 may include a second image or coloring scheme. For example, in the embodiment illustrated in FIG. 2, the first side 206 of the sheet of material 204 is colored to represent an animal's shadow 202. In one embodiment, the shadow 202 may be long, as a real shadow would look in the early morning or late evening (typical hunting hours). In other embodiments, the shadow 202 may be configured to represent a shadow 202 at any given point of the suns position.

The second side 304, as shown in FIG. 3, includes an image depicting a reflection 302 of a duck. In other embodiments, both sides of the sheet of material 204 may include the same image or coloring scheme.

In certain embodiments, the apparatus 200 is an artificial floating reflection 302 or dark shadow 202 used to aid in the attraction of birds, such as waterfowl. The apparatus 200 may be used by itself or attached to a floating waterfowl decoy 100 to simulate and/or enhance the decoys 100 reflection 302 or shadow 202 off of the water or on land.

The apparatus 200 to simulate one of a reflection 302 and a shadow 202 of an animal can be used either floating on a water surface by itself or placed on the ground as in field hunting. In one embodiment, the apparatus 200 simulate one of a reflection 302 and a shadow 202 of an animal can be of varying lengths and widths to simulate the shadow 202 and/or reflection 302 of a decoy 100 or live bird at differing times of the day and at different sun positions. In other embodiments, the apparatus 200 can be made over sized so that high flying birds can more readily be attracted to the decoy 100.

In one embodiment one side of the apparatus 200 to simulate one of a reflection 302 and a shadow 202 of an animal is printed with a simulated reflection 302 of a decoy 100 or bird on a first side of the apparatus 200. In such an embodiment, the other the side of the apparatus 200 may be printed with a dark material to simulate a shadow 202 of the decoy 100 or bird. The simulated reflection 302 and/or the simulated shadow 202 may be of the entire aerial view of the bird or decoy 100 when looking straight down or just a profile silhouette view of the bird or decoy 100.

In certain embodiments, the apparatus 200, in addition to allowing waterfowl see the decoy 100 from greater distances and from greater angles, is also made of a buoyant material. As an example, rubber or neoprene material can be printed on one side to simulate the reflection 302 and on the other side to simulate a bird's shadow 202. In such an embodiment, the apparatus 200 may also stabilize floating decoys 100. For example, in one embodiment, the apparatus 200 is removably coupled to either the side (106 or 108) of the decoy 100 or the keel 104 of the decoy 100.

In embodiments wherein the apparatus 200 is made of a buoyant material, the apparatus provides the decoy 100 with greater stability against waves and/or wind when the decoy 100 is floating in or on water. When made out of buoyant rubber the apparatus 200 becomes light weight, durable, keeps its form, and bends with the waves as a waterfowl would when floating on the water.

In certain embodiments, the apparatus 200 may be used with a decoy 102 primarily designed to be used on land. In such an embodiment, the apparatus 200 be made of any ridged flat or semi flat material. A rigid material assists in maintaining the decoy 102 in an upright orientation.

As discussed above, in certain embodiments, the apparatus 200 includes a coupling member configured to removably couple the sheet of material 204 to the decoy 102. In one embodiment, the sheet of material 204 is removably coupleable to the decoy 102 along either the first side 106 of the decoy 102, the second side 108 of the decoy 102, or both. In other embodiments, the sheet of material 204 is removably coupleable to the keel 104 of the decoy 102.

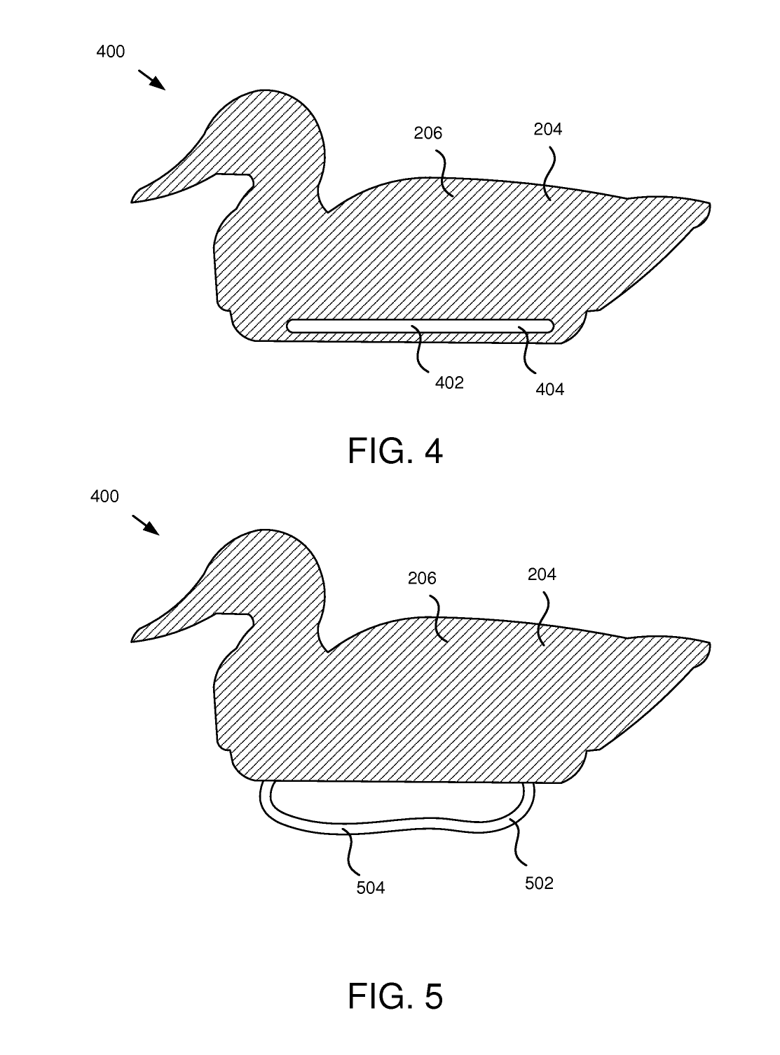

While the embodiments described above discuss an apparatus 200 simulate either a reflection 304 or a shadow 202 of an animal, one of skill in the art will recognize that the reflection 304 and/or the shadow 202 are removably coupleable to the decoy 102 to enhance the decoy 102. Thus, in certain embodiments, the apparatus 200 may be used to enhance a decoy 102. Of course, one of skill in the art will recognize that the apparatus discussed below with regard to FIGS. 4-9 may also be used to enhance a decoy 102 or decoys 102.

FIG. 4 is a top view illustrating an apparatus 400 to simulate one of a reflection 304 and a shadow 202 of an animal in accordance with one embodiment of the present subject matter. In certain embodiments, the apparatus 400 includes a sheet of material 204 and a coupling member 402.

The sheet of material 204 is substantially similar to the sheet of material 204 of apparatus 200. Thus, in certain embodiments, the sheet of material 204 has a first side 206 disposed opposite a second side 304. The sheet of material 204 has a profile shaped in the silhouette of an animal. In one embodiments, the first side 206, the second side 304 or both sides (206 and 304) of the sheet of material 204 are colored to simulate an animal's shadow 202. In other embodiments, the first side 206, the second side 304 or both sides (206 and 304) of the sheet of material 204 include an image that simulates an animal's reflection 302.

In the embodiment illustrated in FIG. 4, the coupling member 402 is an aperture 404 that extends through the sheet of material 204. The aperture 404 is sized to receive the keel 104 of the decoy 102 to removably couple the sheet of material 204 to the decoy 102. To couple the apparatus 400 to the decoy 102, the keel 104 of the decoy 102 is positioned through the aperture 404. To remove the apparatus 400 from the decoy 102, a user simply slides the keel 104 of the decoy 102 out from within the aperture 404 in the sheet of material 204.

In one embodiment, the sheet of material 204 may be made of an elastic material. In such an embodiment, the aperture 404 is sized to elastically extend about the keel 104 of the decoy 102. An elasticity of the sheet of material 204 maintains the aperture 404 about the keel 104 of the decoy 102 to removably couple the sheet of material 204 to the decoy 102.

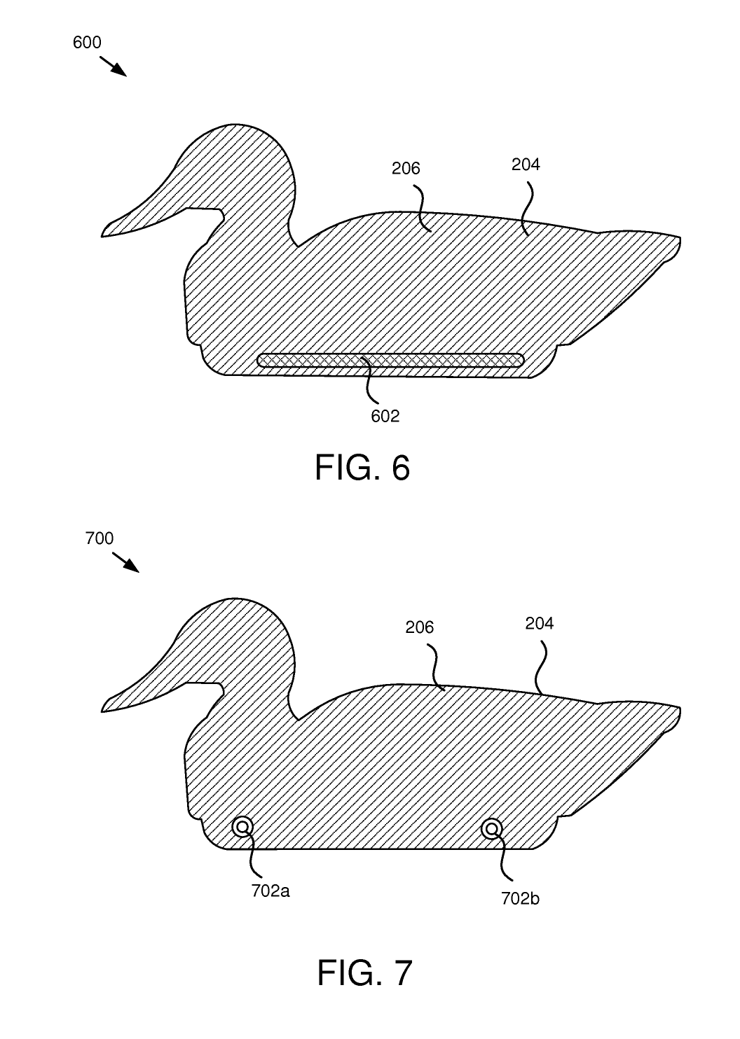

FIG. 5 is a top view illustrating another embodiment of an apparatus 500 to simulate one of a reflection 304 and a shadow 202 of an animal. The apparatus 500 includes a sheet of material 204 and a coupling member 502. The sheet of material 204 is substantially similar to the sheet of material 204 of apparatus 200 and 400 discussed above.

In the embodiment illustrated in FIG. 5, the coupling member 502 is a band 504 that is positionable about the keel 104 of the decoy 102 to removably couple the apparatus 500 to the decoy 102. In certain embodiments, the band is simply a chord, ribbon, or other elongated piece of material that extends around the keel 104 of the decoy 102 to removably couple the apparatus 500 to the decoy 102. In such an embodiment, the apparatus 500 may include a tightening device (i.e., a chord locking device as is found on sleeping bags) to tighten the band 504 around the keel 104 to keep the apparatus 500 coupled to the decoy 102. To uncouple the apparatus 500 from the decoy 102, the tightening device is loosened and the band 502 is removed from around the keel 104.

In other embodiments, the band 502 may be made of an elastic material. In such an embodiment, the band 502 is sized to elastically extend about the keel 104 of the decoy 102. An elasticity of the band 502 maintains the band 502 about the keel 104 of the decoy 102 to removably couple the sheet of material 204 to the decoy 102.

In other embodiments, the apparatus to enhance a decoy may include coupling elements attached to both the decoy 102 as well as the sheet of material 204. For example, FIG. 6 depicts one embodiment of an apparatus 600 to simulate one of a reflection 304 and a shadow of an animal 202 of an animal. The apparatus 600 includes a sheet of material 204 and a coupling member 602. The sheet of material 204 is substantially similar to the sheet of material 204 of apparatus 200, 400, and 500 discussed above.

In the embodiment illustrated in FIG. 6, the coupling member 602 is a hook and loop fastening system 604 that includes a first coupling element (i.e., a hook portion of a hook and loop fastening system) and a second coupling element (i.e., a loop portion of a hook and loop fastening system). One of skill in the art will recognize that either the first coupling element or the second coupling element can be couple to the sheet of material 204 with the other of the first coupling element or the second coupling element being coupled to the decoy 102. In such an embodiment, the first coupling element (the hook portion of a hook and loop fastening system) is engageable with the second coupling element (the loop portion of a hook and loop fastening system) to removably couple the sheet of material 204 to the decoy 102. One of skill in the art will recognize that the apparatus may be coupled to the decoy 102 at either side (106 or 108) of the decoy 102 or on the keel 104 of the decoy 102.

FIG. 7 illustrates a top view of another embodiment of an apparatus 700 to simulate one of a reflection 304 and a shadow 202 of an animal wherein the apparatus includes coupling elements attached to both the decoy 102 as well as the sheet of material 204.

In the embodiment illustrated in FIG. 7, the coupling member is a snap fastening system that includes a male portion of a snap fastener that is configured to be received within a female portion 702a and 702b of the snap fastener (in the embodiment illustrated in FIG. 7 only the female portions 702a and 702b of the snap fasteners are depicted). In such an embodiment, corresponding male portions of the snap fasteners (not shown) are coupled to either side (106 or 108) of the decoy 102 or on the keel 104 of the decoy 102. Together, the female portions 702a and 702b and the male portions of the snap fasteners operate to removably couple the apparatus 700 to a decoy 102.

While the embodiment illustrated in FIG. 7 depicts the female portions 702a and 702b of the snap fastening system as being coupled to the sheet of material 204, one of skill in the art will recognize that in other embodiment, the male portion of the snap fastening system. Similarly, while only two female portion 702a and 702b of a snap fastening system are shown, one of skill in the art will recognize that in other embodiments, the apparatus 700 may include greater or fewer snap fasteners.

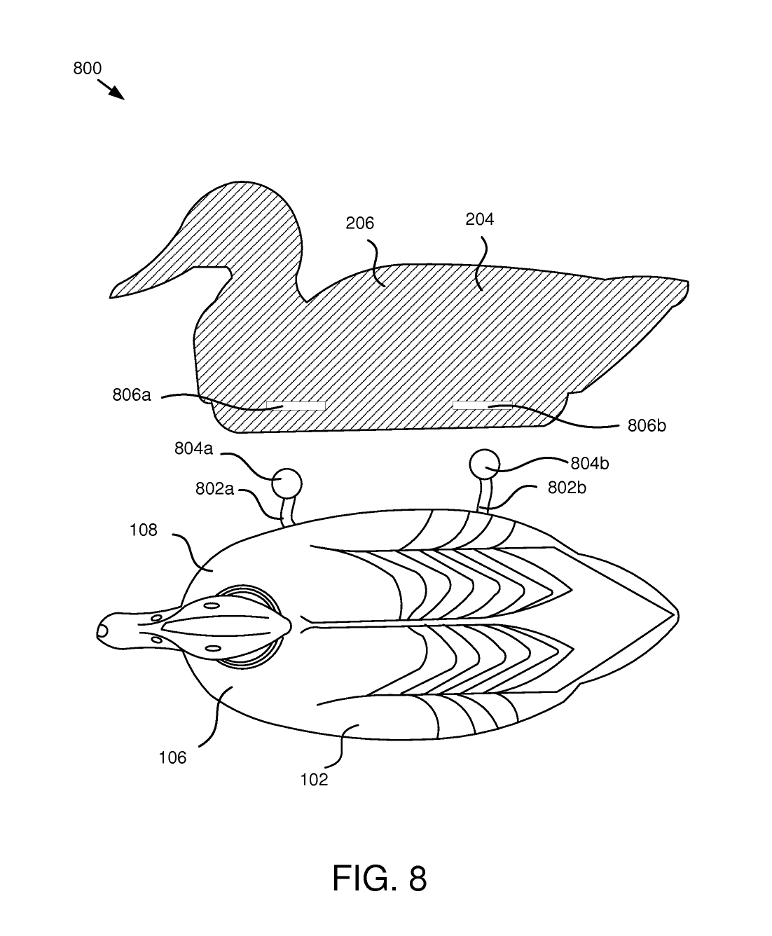

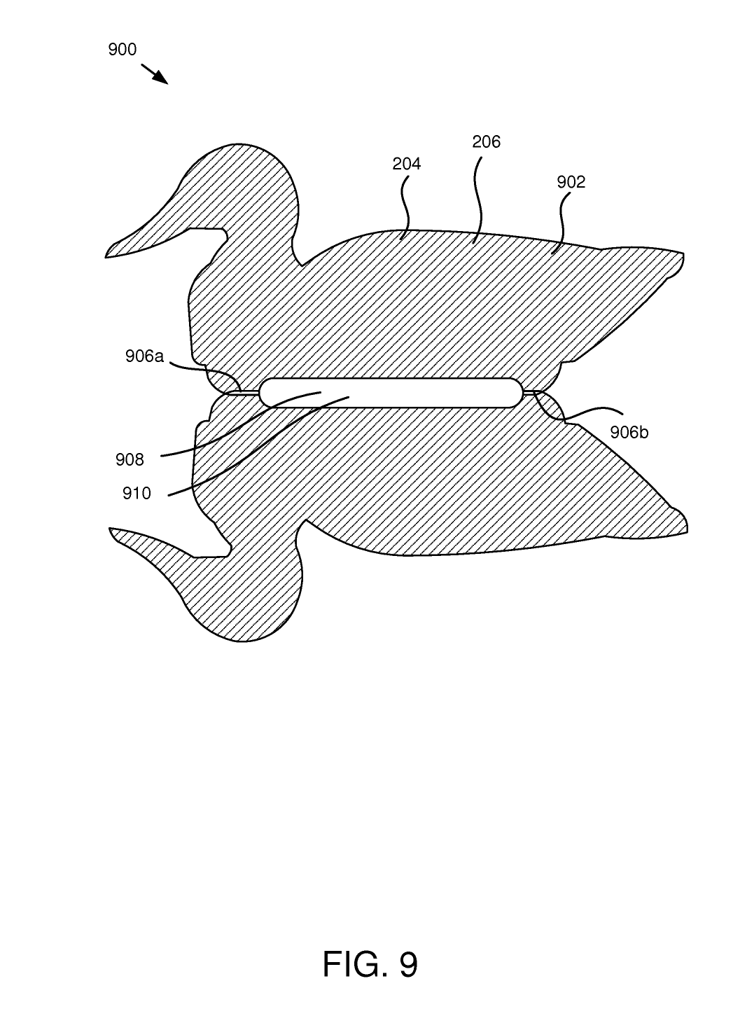

FIG. 8 illustrates a top view of another embodiment of an apparatus 800 to simulate one of a reflection 304 and a shadow 202 of an animal. In the embodiment illustrated in FIG. 8, the coupling member is a pair of straps 802a and 802b extending from a side 108 of the decoy 102. The straps 802a and 802b terminate with fastening elements 804a and 804b. In the embodiment illustrated in FIG. 8, the fastening elements 804a and 804b are enlarged elements (i.e., enlarged spheres) that are positionable through slots 806a and 806b in the sheet of material 204 to removably couple the sheet of material 204 to the decoy 102.

FIG. 9 is a top view illustrating an apparatus 800 to simulate one of a reflection 304 and a shadow 202 of an animal according to another embodiment of the present invention. In the embodiment illustrated in FIG. 9, the sheet of material 204 includes two profiles shaped in the silhouette of an animal, a first profile 902 and a second profile 904. The first profile 902 is a mirror image of the second profile 904 with a bottom portion 906a and 906b of each profile (902 and 904) touching one another.

In the embodiment illustrated in FIG. 9, the coupling member 908 is an aperture 404 that extends through the sheet of material 204. The aperture 404 is sized to receive the keel 104 of the decoy 102 to removably couple the sheet of material 204 to the decoy 102. One of skill in the art will recognize that in other embodiments, the apparatus 900 may include a different coupling member 908 other than an aperture 404 extending through the sheet of material 204.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to simulate one of a reflection and a shadow of an animal, the apparatus comprising:
a sheet of material having a first side disposed opposite a second side, the sheet of material having a profile shaped in a silhouette of an animal; and
a coupling member configured to removably couple the sheet of material to a decoy.

2. The apparatus of claim 1, wherein the sheet of material is removably coupleable to the decoy at one of a side of the decoy and a keel of the decoy.

3. The apparatus of claim 1, wherein the coupling member comprises an aperture in the sheet of material, the aperture sized to receive a keel of a decoy to removably couple the sheet of material to the decoy.

4. The apparatus of claim 3, wherein the sheet of material comprises an elastic material and wherein the aperture is sized to elastically extend about the keel of the decoy, wherein an elasticity of the sheet of material maintains the aperture about the keel of the decoy to removably couple the sheet of material to the decoy.

5. The apparatus of claim 1, wherein the coupling member comprises a band positionable about a keel of a decoy to removably couple the sheet of material to the decoy.

6. The apparatus of claim 1, wherein the coupling member comprises a first coupling element and a second coupling element, the first coupling element attached to the sheet of material, the second coupling element attached to the decoy, the first coupling element engageable with the second coupling element to removably couple the sheet of material to the decoy.

7. The apparatus of claim 1, wherein the coupling member comprises a hook and loop fastening system, wherein one of a hooking portion and a loop portion of the hook and loop fastening system is attached to the sheet of material and wherein the other of the hooking portion and a loop portion of the hook and loop fastening system is attached to the decoy.

8. The apparatus of claim 1, wherein the coupling member comprises a snap fastening system.

9. The apparatus of claim 1, wherein the coupling member comprises at least one strap extending from at least one of the side of the decoy and the keel of the decoy, wherein a terminating end of the at least one strap includes a fastening element, the fastening element removably coupleable with the sheet of material.

10. The apparatus of claim 1, wherein the first side of the sheet of material is colored to simulate an animal's shadow and wherein the second side of the sheet of material includes an image, the image colored to simulate a reflection of the animal.

11. The apparatus of claim 1, wherein the profile shaped in the silhouette of the animal comprises a first profile and wherein the sheet of material includes a second profile shaped in the silhouette of the animal, the second profile mirroring the first profile.

12. An apparatus to enhance a decoy, the apparatus comprising:
a sheet of material having a first side disposed opposite a second side, the sheet of material having a profile shaped in a silhouette of an animal; and
a coupling member configured to repeatedly couple and uncouple the sheet of material to a decoy.

13. The apparatus of claim 12, wherein the sheet of material is repeatedly coupleable and uncoupleable to the decoy at one of a side of the decoy and a keel of the decoy.

14. The apparatus of claim 12, wherein the coupling member comprises an aperture in the sheet of material, the aperture sized to receive a keel of a decoy to repeatedly couple and uncouple the sheet of material to the decoy.

15. The apparatus of claim 12, wherein the coupling member comprises a band positionable about a keel of a decoy to repeatedly couple and uncouple the sheet of material to the decoy.

16. The apparatus of claim 12, wherein the coupling member comprises a first coupling element and a second coupling element, the first coupling element attached to the sheet of material, the second coupling element attached to the decoy, the first coupling element engageable with the second coupling element to repeatedly couple and uncouple the sheet of material to the decoy.

17. The apparatus of claim 12, wherein the profile shaped in the silhouette of the animal comprises a first profile and wherein the sheet of material includes a second profile shaped in the silhouette of the animal, the second profile mirroring the first profile.

18. An apparatus to enhance a decoy, the apparatus comprising:
a sheet of material having a first side disposed opposite a second side, the sheet of material having a profile shaped in a silhouette of an animal;
a coupling member configured to repeatedly couple and uncouple the sheet of material to a decoy; and
wherein the sheet of material is repeatedly coupleable and uncoupleable to the decoy at one of a side of the decoy and a keel of the decoy.

19. The apparatus of claim 18, wherein the coupling member comprises an aperture in the sheet of material, the aperture sized to receive a keel of a decoy to repeatedly couple and uncouple the sheet of material to the decoy.

20. The apparatus of claim 18, wherein the coupling member comprises a band positionable about a keel of a decoy to repeatedly couple and uncouple the sheet of material to the decoy.
